(19) United States
(12) Patent Application Publication
(10) Pub. No.: US 2014/0214494 A1
(43) Pub. Date: Jul. 31, 2014

(54) CONTEXT-AWARE INFORMATION ITEM RECOMMENDATIONS FOR DEALS

(71) Applicant: HEWLETT-PACKARD DEVELOPMENT COMPANY, L.P., Houston, TX (US)

(72) Inventors: Ashutosh Sopan Jadhav, Fairborn, OH (US); Hamid Reza Motahari Nezhad, Los Altos, CA (US); Susan D. Spence, Cambridge (GB); Claudio Bartolini, Palo Alto, CA (US)

(73) Assignee: Hewlett-Packard Development Company, L.P., Houston, TX (US)

(21) Appl. No.: 13/750,187

(22) Filed: Jan. 25, 2013

(51) Int. Cl. G06Q 10/06

(52) U.S. Cl. CPC G06Q 10/0637
USPC 705/7.36

(57) ABSTRACT

Systems, methods, and machine-readable and machine-executable instructions are provided to determine context-aware information item recommendations for deals. An example of a computing system to determine context-aware information item recommendations can extract a set of information concerning pursuit of a deal by an enterprise, where a first portion of the set can be extracted from an electronic communication network and a second portion of the set can be extracted from a profile of elements to be included in a completed deal. The computing system can form a context-aware query by determination of semantic relevance of the set of information and can determine an output based upon correlation of the context-aware query with content of a resource description framework (RDF) triple store, where the output includes the context-aware information item recommendations for the deal.

### BACKGROUND

An enterprise may receive many requests and/or proposals from prospective clients for providing equipment, product, and/or service deals (e.g., contracts relating to maintaining and/or improving functionality of the equipment, the products, facilities, personnel, etc.). Pursuit teams may be formed by the enterprise to investigate the prospects (e.g., anticipated resources required, profitability, etc.) of such potential deals. The pursuit teams may benefit from using information from past deals felt to be relevant as a reference for determining appropriate deal structuring and/or pricing. However, sharing and accessing the right information (e.g., the information from the past deals) at the right time (e.g., at various points in a multistage process) may be a challenge for the pursuit teams in efficiently preparing proposed deals.

### BRIEF DESCRIPTION OF THE DRAWINGS

FIG. 1 is a block diagram illustrating an example of a system to determine context-aware information item recommendations for deals according to the present disclosure.

FIG. 2 is a block diagram illustrating an example of implementing a system to determine context-aware information item recommendations for deals according to the present disclosure.

FIG. 3 is a block diagram illustrating an example of a computing system to determine context-aware information item recommendations for deals according to the present disclosure.

FIG. 4 is a block diagram illustrating an example of memory resources with processing resources to determine context-aware information item recommendations for deals according to the present disclosure.

### DETAILED DESCRIPTION

Deal document recommendations to be used as templates, examples, and/or suggestions for determining appropriate deal structuring and/or pricing for providing equipment, product, and/or service deals (e.g., contracts relating to maintaining and/or improving functionality of the equipment, the products, facilities, personnel, etc.) to be offered to prospective clients may include user-based recommendations and content-based recommendations. The user-based recommendations may be based on popularity of deal contents among other users, while the content-based recommendations may consider relevancy of information in past deals in making recommendations (e.g., based on text content and/or syntactical information).

However, these approaches do not consider process progression information related to a multistage pursuit process in making recommendations, as described herein. Nor do these approaches utilize semantic relevance and/or semantic web approaches to analyze surrounding information and/or metadata, among other information, as described herein. As such, these approaches are not context-aware, in contrast to the systems, methods, and machine-readable and machine-executable instructions described herein.

To contribute to efficiency of pursuit teams of an enterprise in preparing deal proposals to be offered to a client, the present disclosure describes context-aware information item recommendations for the deal. Such context-aware information item recommendations can be accessible to and/or influenced by input from, for example, each member of a pursuit team connected to preparing a particular deal proposal via a system that includes an electronic communication network (e.g., an enterprise social network (ESN) to connect the pursuit team members, among other functions described herein). Doing so can expedite the deal pursuit process by making the right recommendation at the right time. For example, the context-aware information item recommendations can be recommendations that are output (e.g., presented to a user) as a ranked list of relevant information items (e.g., historical deal documents related to past completed or partial deals, or portions thereof, metadata contained therein and/or associated therewith, process stage descriptions, and related documents and/or artifacts, among other recorded information items) determined to be most relevant and/or similar to the particular deal proposal being prepared. Such relevance and/or similarity can be determined by using semantic representation and understanding of the data, information relevancy factors, information shared on the ESN, and/or considering the current stage of a multistage pursuit process, among other considerations.

Examples of the present disclosure include systems, methods, and machine-readable and machine-executable instructions to determine context-aware information item recommendations for deals. An example of a computing system to determine context-aware information item recommendations can include a memory and a processor resource coupled to the memory, as described herein. The computing system can extract a set of information concerning pursuit of a deal by an enterprise, where a first portion of the set can be extracted from an electronic communication network (e.g., the ESN) and a second portion of the set can be extracted from a profile of elements (e.g., various pieces of equipment, various products, various functions, various services, etc.) to be included in a completed deal. The computing system can form a context-aware query by determination of semantic relevance of the set of information and can determine an output based upon correlation of the context-aware query with content of a resource description framework (RDF) triple store, where the output includes the context-aware information item recommendations for the deal.

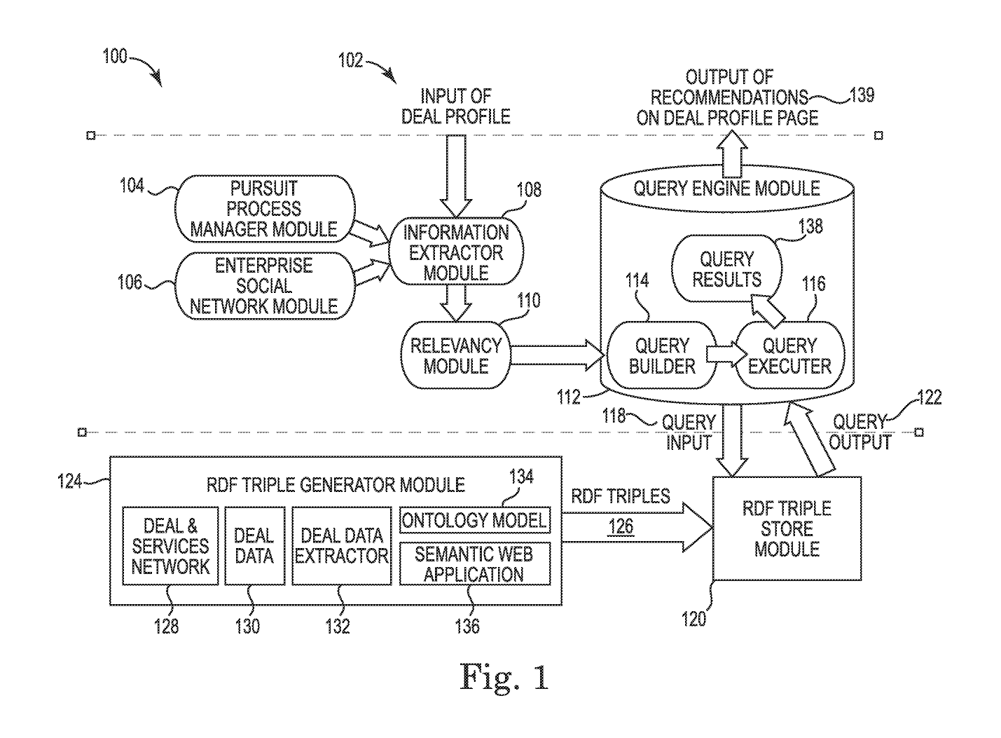

FIG. 1 is a block diagram illustrating an example of a system to determine context-aware information item recommendations for deals according to the present disclosure. In the detailed description of the present disclosure, reference is made to the accompanying drawings that form a part hereof and in which is shown by way of illustration how examples of the disclosure may be practiced. These examples are described in sufficient detail to enable one of ordinary skill in the art to practice the examples of this disclosure and it is to be understood that other examples may be utilized and that process, electrical, and/or structural changes may be made without departing from the scope of the present disclosure. As used herein, “a” or “a number of” an element and/or feature can refer to one or more of such elements and/or features. Further, where appropriate, as used herein, “for example” and “by way of example” should be understood as abbreviations for “by way of example and not by way of limitation”. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

As illustrated in FIG. 1, the example of the system 100 to determine context-aware information item recommendations for deals can include input of a deal profile 102. The deal profile 102 can, for example, have elements (e.g., various pieces of equipment, products, various functions, various services, timing and/or frequency of provision of the same, etc.) anticipated by the enterprise (e.g., members of the pursuit team, technicians, administrators, etc.) and/or the client to be included in a completed deal. The deal profile 102 can be input into the system 100, for example, via a graphical user interface (GUI) (not shown). The deal profile 102 that is input can be stored on a deal profile page (not shown) that, in some examples, can be revised as pursuit of the deal advances (e.g., progression of the deal-making process through multiple stages).

Information (e.g., the elements, etc.) from the deal profile 102 can be input to an information extractor module 108 of the system 100. The information extractor module 108 can automatically extract information from the deal profile 102, a pursuit process manager module 104, and/or an ESN module 106.

A deal pursuit process can be a multistage process in which each stage has a number of pursuit team members that may refer to different historical deal-related documents and/or portions thereof as possible sources for context-aware information item recommendations. Depending upon a particular stage of the pursuit process, the pursuit team members may have different levels of knowledge about details of advancing toward completion of the new deal. A pursuit process manager (e.g., with instructions and/or memory stored in the pursuit process manager module 104) can coordinate progress through the previous, current, and/or upcoming stages of the pursuit process. The pursuit process manager module 104 can keep track of a current stage of the pursuit process.

For example, the pursuit process manager module 104 can focus a search for historical deal-related documents and/or portions thereof upon those with relevancy to a particular stage (e.g., the current stage) in the multistage pursuit process. As described herein, context-aware information item recommendations can be extracted from and/or as historical deal documents related to past completed or partial deals, or portions thereof, metadata contained therein and/or associated therewith (e.g., related to pricing, services, and/or the client, among many other types of metadata), process stage descriptions, and related documents and/or artifacts, among other recorded information items.

The ESN module 106 can connect pursuit team members and pursuit documents (e.g., a deal profile page, a services profile page, etc.) with each other. Each pursuit team member and each pursuit document can have a profile page. A profile page for a pursuit team member can include the pursuit team member's name, contact information, position in a hierarchy of the enterprise, past projects, roles and responsibilities, interests, among other relevant information. Pursuit team members working on a deal can have a number of group pages on the ESN where they share information, tag, bookmark, and/or “like” the information relevant to the deal on which they are working. Recommendations for relevant past information items (e.g., historical deal documents, etc.) can be made by the pursuit team members on the deal profile page and as more details are determined, as described herein, the deal profile page can be updated with more relevant context-aware information items recommendations. A profile page for pursuit documents can include various informative metadata. For example, a deal profile page can contain information about the prospective deal that includes various details (e.g., metadata) related to the deal and/or the client (e.g., the name of the client, the country of the client, the type of industry, the type of deal, among many other metadata possibilities).

The information from the deal profile 102, pursuit process manager module 104, and/or the ESN module 106 can be input to the information extractor module 108. The information extractor module 108 automatically extracts information from the deal profile 102, pursuit process manager module 104, and/or the ESN module 106. For example, the information extractor module 108 extracts deal metadata (e.g., client name, country, industry, and/or deal type, etc.) from the deal profile 102, information about the current stage of the pursuit process from the pursuit process manager module 104, and information shared by the pursuit team on the ESN module 106 (e.g., information that has been tagged, bookmarked, and/or liked by pursuit team members).

The information extracted by the information extractor module 108 can be input to a relevancy module 110. The relevancy module 110 can be utilized to define a contextual weighting scheme for various query parameters to calculate the information items' (e.g., historical deal documents', etc.) relevance scores. A contextual weighting scheme can be defined, for example, based at least partially upon contextual information retrieved from the other modules (e.g., the pursuit process stage, information shared on the ESN, etc.). The relevancy module 110 can contribute to output of a ranked list of information items (e.g., historical deal documents, etc.) as recommendations based on the relevancy score. Among various examples, the relevancy score can be based upon a numerical scale (e.g., by way of example and not by way of limitation, based upon a continuous range from 0.0 to 10.0) with a higher score number indicating an information item having a higher relevancy than an information item with a lower score number.

A context-aware query formed by a query engine module 112 has semantic relevance based upon the query parameters determined by the information extractor module 108 and the defined contextual weighting scheme for the various query parameters determined by the relevancy module 110. Semantic relevance among information resources can play an effective role in information retrieval. Ontology-based semantic technology provides an avenue to enhance information retrieval and knowledge sharing. For retrieving information, a list of results can be provided based upon input of a given query. However, the search result is often centered upon relevance between the given query and each resource (e.g., document), and to find other resources that are similar or relevant to a particular resource often results in returning to the previous results list or initiating another query. Since each resource representing different knowledge is semantically connected to each other, measuring and/or utilizing the semantic relevance between those resources can provide a more flexible range of results that are not strictly limited to the given query. Such a measure can also be used to provide a guideline or recommendation on what other resources are related and are suggested to be considered when the user is examining a certain resource.

Semantic similarity can be defined as the likeness of the semantic content among documents or the meaning among a set of structured terms, and there are several methods to discover the semantic similarities among concepts and/or resources (e.g., documents). Semantic relevance can be defined as a measurement to calculate the relevance between resources as numeric values based on the semantic relations between the concepts and/or resources. To measure the semantic relevance between resources, the resources (e.g., documents) can be semantically structured and represented. An ontology can be utilized for this purpose. Such an ontology can be constructed in a number of different ways, depending on the purpose of the system and the type of resources being managed. The ontology can, for example, be designed such that some classes contain resources whereas other classes represent other semantic concepts. For example, an ontology can have a class called Documents containing all the resources in a document format and another class called Persons containing personal profiles, which might not be regarded as resources—hence not as target objects for searching—but may be used as additional semantic information to produce, for instance, personalized search results. Alternatively, all classes can represent resources within the ontology. In this case, personal profiles can also be regarded as resources and, hence, they are also the target objects for searching.

Once the structure of the ontology—the concepts, attributes, and properties—is defined, a set of rules can be defined to specify additional semantic information. A numeric value can be assigned for each relation or rule, representing a semantic distance between concepts (e.g., classes). The semantic distance can be considered the opposite (e.g., the inverse) of semantic relevance in that the higher the value for the semantic distance is the less relevant to each other the given two concepts are.

The output of the relevancy module 110 is input to the query engine module 112. In some examples, the query engine module 112 can include three sub-modules for query formation (e.g., a query builder sub-module 114), query execution (e.g., a query executor sub-module 116), and/or handling of query results (e.g., a query results sub-module 138). In various examples, the output of the relevancy module 110 can be directed to a query builder 114 in the query engine module 112. The query builder 114 can form a query (e.g., in SPARQL Protocol and RDF Query Language (SPARQL)) based upon information extracted by the information extractor module 108 and relevancy information provided by the relevancy module 110. The formulated query can be sent to a query executor 116 that executes a query input 118 (e.g., in SPARQL) to an RDF triple store module 120.

After correlation (e.g., processing) of the query input 118 in relation to the content of the RDF triple store module 120, a query output 122 is returned to the query engine module 112. The query output 122 can be in the form of RDF triples corresponding to relevant historical information items (e.g., deal documents, etc.) selected in response to the query input 118. The query output 122 can be stored in a query results sub-module 138. The query results sub-module 138 can, in various examples, select a top 2 to 30 of the historical information items (e.g., with the number selected being variable as determined by input from pursuit team managers and/or members, input from the pursuit process manager module 104, and/or a number of RDF triples in the query output 122, among other determinants of the number selected). The historical information items can be selected based upon a relevancy score (e.g., the historical information items with the highest relevancy score numbers). The selected historical information items can be sent as output of context-aware information item recommendations to be presented (e.g., ranked) on the deal profile page 139 (e.g., as updated from the input of the deal profile 102).

The content of the RDF triple store module 120 can be determined by an RDF triple generator module 124 that supplies input in the form of RDF triples 126 to the RDF triple store module 120. The RDF triple generator module 124 can, in various examples, convert data with a deal data extractor 132 from historical deal-related documents stored in and/or accessed through a deal and services network 128 and/or archived deal data 130 into more semantic data by generating the RDF triples 126. In some examples, an ontology model 134 and/or a semantic web application 136 can contribute to generating the RDF triples 126.

Accordingly, the RDF triple generator module 124 can process historical deal-related documents, which can, for example, be structured documents that contain deal metadata (e.g., client name, country, industry, and/or deal type, etc.) and services included in the deal. Information about types of services offered by the enterprise can be stored and/or accessible on a number of service profile pages. Each service can be composed of a set of service packages usable in a multistage process. The historical deal-related documents can provide additional information about the services and/or packages included in the services. As such, accessing a particular service profile page can enable cross-reference and/or access to one or more relevant historical deal-related documents and vice versa. Data (e.g., information items) from the historical deal-related documents and the service profile pages can be extracted by parsing the historical deal-related documents and the service profile pages. Extracted data can further go through a cleaning phase to get data into an appropriate data format.

As described herein, an ontology can be determined by analyzing the historical deal-related documents to identify their concepts, their semantics, and a relationship of these concepts with each other. The ontology can be extended by adding related concepts and relationships from services, packages, documents, the pursuit process, and/or the pursuit team. The ontological concepts and relationships can be further enriched with semantics by associating/linking them to Linked Open Data (LOD) datasets. As such, the deal ontology model 134 can, in some examples, interact with the semantic web application 136 of the RDF triple generator module 124 to convert the data from the deal-related documents into the RDF triples 126. For example, the deal ontology model 134 can define namespace for the semantic web application 136. The semantic web applications can be configured using, for example, a Hewlett-Packard Jena framework, which can provide a programmatic environment for RDF, RDFS, OWL, and/or SPARQL, etc., and which can include a rule-based inference engine.

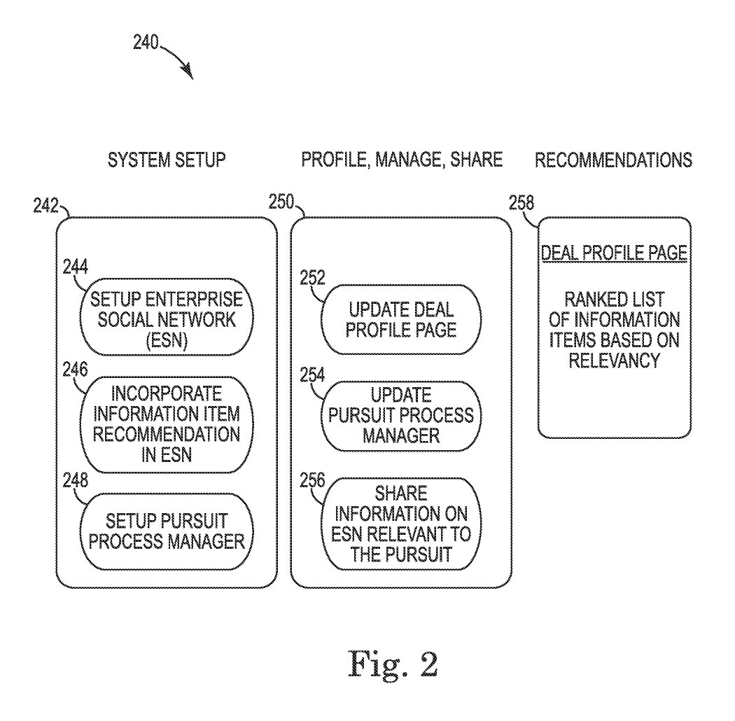

FIG. 2 is a block diagram illustrating an example of implementing a system to determine context-aware information item recommendations for deals according to the present disclosure. As illustrated in the example of implementing the system 240 shown in FIG. 2, system setup 242 can include setup of the electronic communication network 244 (e.g., the ESN, as described herein), incorporation of an information item recommendation functionality 246 in and/or connected with the ESN, and setup of a pursuit process manager 248 in and/or connected with the ESN, as described with regard to FIG. 1. Setup of the ESN 244, the information item recommendation functionality 246, and the pursuit process manager 248 can be performed in any order.

The system 240 can be implemented to profile, manage, and/or share 250 information during the pursuit process intended to result in completion of a deal. For example, information exchanged through the ESN 244 can be implemented to update the deal profile page 252, update the pursuit process manager 254, and/or share information on the ESN relevant to the pursuit 256 (e.g., between pursuit team members, etc.), among other implementations.

The system 240 can be implemented to at least provide output of recommendations 258. The recommendations 258 can, for example, be provided on the deal profile page (e.g., as shown at 139 in FIG. 1 and as updated from the input of the deal profile as shown at 102 in FIG. 1). The deal profile page can include a ranked list of historical information items (e.g., deal documents, etc.), with the ranking based on relevancy of the historical information items to a particular stage of the multistage deal pursuit process.

For example, a specialist can define templates for various types of processes from best practice frameworks of the enterprise. The templates may contain sequences of stages (e.g., actions, determinations, etc.) to be accomplished in the multistage deal pursuit processes rather than how to execute the stages. A specialist who is familiar with enterprise rules, policies, guidelines, and/or best practices may specialize the templates to yield more specific templates (e.g., related to provision of particular equipment, products, services, etc., to particular clients, within particular time windows, etc.). The templates can be supplied by an engine (e.g., associated with the deal and services network 128 of the RDF triple generator module 124 shown in FIG. 1) to assist in initiating a new deal pursuit process among a number of people (e.g., pursuit team members, clients, etc.). While the people are conducting the deal pursuit process, the templates can be refined, for example, into the sequences of stages (e.g., actions, determinations, etc.) to be enacted by the people. Each of the actions, determinations, etc., can be captured in a trace to document a sequence of stages performed by the people in the current deal pursuit process, which can be a historical information item recommended as an example to be used in a number of future deal pursuit processes if determined to have high relevancy thereto.

As described in the present disclosure, a computer-implemented method can be utilized for determining context-aware information item recommendations for deals. Unless explicitly stated, the method elements described herein are not constrained to a particular order or sequence. Additionally, some of the described examples, or elements thereof, can be performed at the same, or substantially the same, point in time.

The computer-implemented method for determining context-aware information item recommendations for deals can include extracting a set of information concerning pursuit of a deal by an enterprise. The set of information can have a first portion of the set that includes metadata extracted from profile pages of an electronic communication network (e.g., the ESN), a second portion of the set including metadata extracted from a profile of elements to be included in a completed deal, and a third portion of the set including context-aware resources relevant to progression toward the completed deal provided by a pursuit process manager. The method can include forming a number of context-aware queries by utilizing the extracted set of information to provide query parameters and by a determination of relevancy for each of the query parameters. The method can include determining an output based upon correlation of the number of context-aware queries with content of an RDF triple store, where the output includes a ranking score for each of the context-aware information item recommendations for the deal.

In some examples, the method can include sharing profile pages of pursuit team members and profile pages of pursuit documents on the electronic communication network (e.g., the ESN), including a deal profile page upon which the ranking score is shown for each of the context-aware information item recommendations. As described herein, the context-aware information item recommendations can be updated based at least partially upon additional information extracted from any of updated profile pages on the electronic communication network, an updated profile of elements to be included in the completed deal, and an update of the context-aware resources of the pursuit process manager.

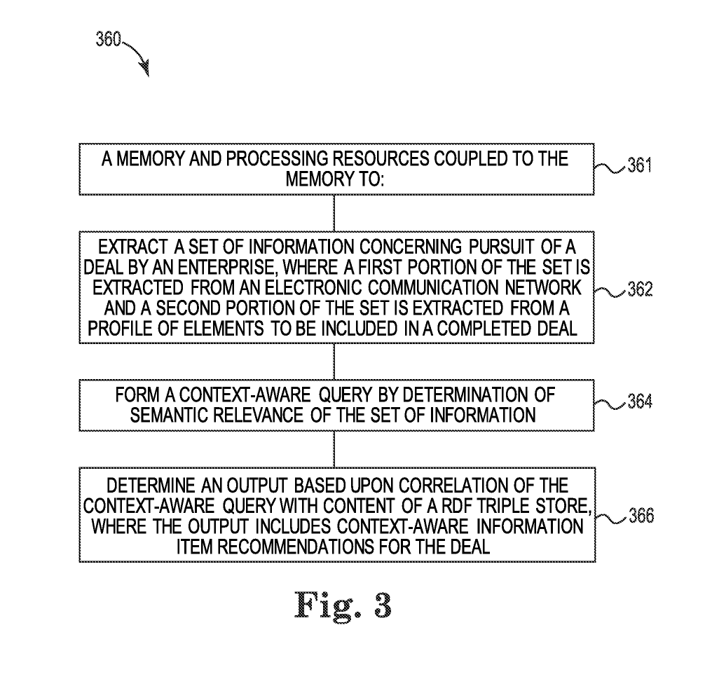

FIG. 3 is a block diagram illustrating an example of a computing system to determine context-aware information item recommendations for deals according to the present disclosure. The example of the computing system 360 illustrated in FIG. 3 can include a memory and processing resources coupled to the memory 361, as shown in block 361. As shown in block 362, the computing system 360 can extract a set of information concerning pursuit of a deal by an enterprise, where a first portion of the set can be extracted from an electronic communication network (e.g., the ESN) and a second portion of the set can be extracted from a profile of elements (e.g., various pieces of equipment and/or products, various functions, various services, etc.) to be included in a completed deal. The computing system 360 can form a context-aware query by determination of semantic relevance of the set of information, as shown in block 364, and can determine an output based upon correlation of the context-aware query with content of an RDF triple store, where the output includes the context-aware information item recommendations for the deal, as shown in block 366.

In some examples, the computing system 360 can include a third portion of the set of information from a pursuit process manager (e.g., a number of modules for storage of particular sets of instructions to direct execution of particular functions, as described herein) that provides context-aware resources relevant to progression (e.g., from beginning-to-end) toward the completed deal (e.g., the multistage deal pursuit process). The system 360 can, in various examples, output a set (e.g., two or more) of context-aware information item recommendations, where the recommendations are ranked based at least partially upon a determination of semantic distance from the context-aware query. The semantic distance can at least partially be a determination of similarity between the set of information concerning pursuit of the deal and elements of previous deals (e.g., contained in historical deal-related documents) at least partially completed by the enterprise. The set of context-aware information item recommendations can, in various examples, be numerically ranked (e.g., with a score) based upon the semantic distance from the context-aware query.

The computing system 360 can include, in various examples, an RDF triple generator to supply RDF triples to the RDF triple store, where the RDF triple generator extracts data concerning the enterprise's at least partially completed deals from either of (e.g., at least one of) a deal data store and/or a deal and services network to at least partially generate an RDF triple. In various examples, the system 360 can, as described herein, include utilization of an ontology model and/or a semantic web application to generate the RDF triple.

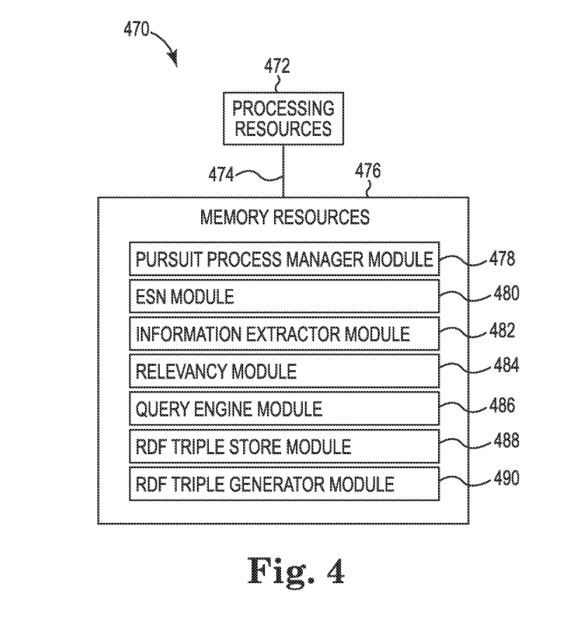

FIG. 4 is a block diagram illustrating an example of memory resources with processing resources to determine context-aware information item recommendations for deals according to the present disclosure. A computing system 470, as described herein, can include a number of computing devices having machine readable memory (MRM) resources 476 and processing resources 472 with machine readable instructions (MRI) (e.g., computer readable instructions) stored in modules of the MRM 476 and executed by the processing resources 472 to, for example, enable determination of context-aware information item recommendations, as described herein. The computing devices of the computing system 470 can be any combination of hardware and/or program instructions (e.g., MRI) configured to, for example, enable determination of the context-aware information item recommendations, as described herein. The hardware, for example, can include a number of interfaces (e.g., GUIs) and/or a number of processing resources 472 (e.g., processors), the MRM 476, etc. The processing resources 472 themselves can include memory resources and the processing resources 472 (e.g., processors) can be coupled to these memory resources. The MRI can include instructions stored in modules on the MRM 476 that are executable by the processing resources 472 to execute one or more of the various actions, functions, calculations, data manipulations, exchange of information, and/or storage, etc., as described herein.

The computing system 470 can include the MRM 476 in communication through a communication path 474 with the processing resources 472. For example, the MRM 476 can be in communication through a number of application servers (e.g., Java® application servers) with the processing resources 472. The computing system 470 can be in communication with a number of tangible non-transitory MRMs 476 storing a set of MRI executable by one or more of the processors of the processing resources 472. The MRI can also be stored in remote memory managed by a server and/or can represent an installation package that can be downloaded, installed, and executed.

The MRM 476, for example, can include a number of modules for storage of particular sets of MRI to direct execution of particular functions, as described herein. For example (e.g., as described herein with regard to FIG. 1), the MRM 476 can include appropriate MRI stored in a pursuit process manager module 478, an ESN module 480, an information extractor module 482, a relevancy module 484, a query engine module 486 (e.g., along with query builder, query executer, and/or query results sub-modules), an RDF triple store module 488, and/or an RDF triple generator module 490 (e.g., along with deal and services network, deal data, deal data extractor, ontology model, and/or semantic web application sub-modules), among other modules described herein.

Processing resources 472 can execute MRI that can be stored on an internal or external non-transitory MRM 476. The non-transitory MRM 476 can be integral, or communicatively coupled, to the computing system 470 in a wired and/or a wireless manner. For example, the non-transitory MRM 476 can be internal memory, portable memory, portable disks, and/or memory associated with another computing resource. A non-transitory MRM (e.g., MRM 476), as described herein, can include volatile and/or non-volatile storage (e.g., memory). The processing resources 472 can execute MRI stored in the modules to perform the actions, functions, calculations, data manipulations, information exchange, and/or storage, etc., as described herein. For example, the processing resources 472 can execute MRI stored in modules 478, 480, 482, 484, 486, 488, and/or 490 to enable determination of context-aware information item recommendations, as described herein.

The MRM 476 can be in communication with the processing resources 472 via the communication path 474. The communication path 474 can be local or remote to a machine (e.g., a computing device) associated with the processing resources 472. Examples of a local communication path 474 can include an electronic bus internal to a machine (e.g., a computing device) where the MRM 476 is volatile, non-volatile, fixed, and/or removable storage medium in communication with the processing resources 472 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 474 can be such that the MRM 476 can be remote from the processing resources 472, such as in a network connection between the MRM 476 and the processing resources 472. That is, the communication path 474 can be a number of network connections. Examples of such network connections can include LAN, WAN, PAN, and/or the Internet, among others. In such examples, the MRM 476 can be associated with a first computing device and the processing resources 472 can be associated with a second computing device. For example, such an environment can include a public cloud system and/or a private cloud system to enable determination of context-aware information item recommendations, as described herein.

As described in the present disclosure, a non-transitory MRM can, in various examples, be utilized for storing a set of instructions (e.g., MRI stored in a number of modules) for determining context-aware information item recommendations. The set of instructions is executable by a processor to cause a computer to extract a set of information concerning pursuit of a deal by an enterprise, where a first portion of the set can include metadata extracted from profile pages of an electronic communication network (e.g., the ESN) and a second portion of the set can include metadata extracted from a profile of elements (e.g., various pieces of equipment, various products, various functions, various services, etc.) to be included in a completed deal. The set of instructions is executable by the processor to form a number of context-aware queries by utilizing the extracted set of information to provide query parameters and by a determination of relevancy for each of the query parameters (e.g., to define a weighting schema). The set of instructions is further executable by the processor to determine an output based upon correlation of the number of context-aware queries with content of an RDF triple store, where the output includes the context-aware information item recommendations for the deal. The content of the RDF triple store can, in various examples, be based at least partially upon metadata and services concerning a plurality of previous deals at least partially completed by the enterprise.

The set of instructions can, in various examples, be executable by the processor to present the context-aware information item recommendations on a deal profile page having a number of numerically ranked (e.g., with a score) recommendations ranging from 2 recommendations to 30 recommendations. The set of instructions can, in some examples, be executable by the processor to numerically rank the context-aware information item recommendations based at least partially upon determinations of profitability of deals at least partially completed by the enterprise. For example, the profitability of a deal, or part of a deal in a multistage process, associated with the information item can be utilized to influence the contextual weighting scheme for the various query parameters to calculate the historical information items' relevance scores. That is, in some examples, the relevance score of a historical deal-related document associated with profitability for the enterprise can be increased such that, for example, that historical deal document's position on a list of ranked recommendations (e.g., on a deal profile page) can be improved relative to a number of historical deal documents associated with being less profitable or unprofitable for the enterprise.

The examples of systems described herein can be operated in a number of modes. For example, one mode can be implemented by directly providing the query information to the recommender (e.g., by and in the query engine module 112 shown in FIG. 1) and obtaining the results in a search result manner (e.g., on the output of information item recommendations 139, 258 on a deal profile page shown in FIGS. 1 and 2, respectively). Another mode can be implemented by being plugged into a system that manages enterprise best business practices (e.g., a pursuit management system) interacting with a historical deal database (e.g., the RDF triple generator module 124 and/or the RDF triple store module 120 shown in FIG. 1). For example, for information that is entered relating to a new deal, the pursuit management system can automatically recommend relevant information items (e.g., historical deal documents, etc.) from the historical deal repository to a workspace (e.g., the deal profile page) of the pursuit, which is accessible to a pursuit team member who is logged in to the workspace. As described herein, the recommendation results are dependent on the.context (e.g., the current deal information, the role of the pursuit team member in the pursuit, and/or the stage of the process of the current deal).

There are a number of advantages of the context-aware information item recommendations described in the present disclosure. Such advantages can include the context-aware information item recommendations taking into account multiple sources of information to recommend related information, which can, in various examples as described herein, include the information relevancy, the pursuit process stage, the role of the pursuit team member in the process, the information being shared between the pursuit team members in the ESN, and/or providing a ranked list of relevant historical information items (e.g., deal documents, etc.) as recommendations. The recommendation approach described herein is configurable and can tailor recommendations to the current state in a particular environment (e.g., the particular pursuit process stage). The recommendation approach described herein can blend the information relevance based on semantic web technology with process progression information, as well as information shared in the ESN, to make the context-aware recommendations. For example, because the recommendation approach described herein can include and/or be at least partially based upon semantic web technology, the semantics of the underlying data (e.g., of the historical deal documents, etc.) can be considered in order to provide recommendations of information items that exploit such semantics.

As used herein, “logic” is an alternative or additional processing resource to execute the actions and/or functions, etc., described herein, which includes hardware (e.g., various forms of transistor logic, application specific integrated circuits (ASICs), etc.), as opposed to computer-executable instructions (e.g., software, firmware, etc.) stored in memory and executable by processing resources.

As described herein, a plurality of storage volumes can include volatile and/or non-volatile storage (e.g., memory). Volatile storage can include storage that depends upon power to store information, such as various types of dynamic random access memory (DRAM), among others. Non-volatile storage can include storage that does not depend upon power to store information. Examples of non-volatile storage can include solid state media such as flash memory, electrically erasable programmable read-only memory (EEPROM), phase change random access memory (PCRAM), magnetic storage such as a hard disk, tape drives, floppy disk, and/or tape storage, optical discs, digital versatile discs (DVD), Blu-ray discs (BD), compact discs (CD), and/or a solid state drive (SSD), etc., as well as other types of machine readable media.

It is to be understood that the descriptions presented herein have been made in an illustrative manner and not a restrictive manner. Although specific examples systems, machine-readable media, methods and instructions, for example, for determining context-aware information item recommendations for deals have been illustrated and described herein, other equivalent component arrangements, instructions, and/or device logic can be substituted for the specific examples presented herein without departing from the spirit and scope of the present disclosure.

The specification examples provide a description of the application and use of the systems, machine-readable media, methods, and instructions of the present disclosure. Since many examples can be formulated without departing from the spirit and scope of the systems, machine-readable media, methods, and instructions described in the present disclosure, this specification sets forth some of the many possible example configurations and implementations.

What is claimed:

1. A computing system to determine context-aware information item recommendations for deals, comprising:
a memory; and
processing resources coupled to the memory, to:
extract a set of information concerning pursuit of a deal by an enterprise, wherein a first portion of the set is extracted from an electronic communication network and a second portion of the set is extracted from a profile of elements to be included in a completed deal;
form a context-aware query by determination of semantic relevance of the set of information; and
determine an output based upon correlation of the context-aware query with content of a resource description framework (RDF) triple store, wherein the output comprises the context-aware information item recommendations for the deal.

2. The system of claim 1, comprising output a set of context-aware information item recommendations, wherein the recommendations are ranked based at least partially upon a determination of semantic distance from the context-aware query.

3. The system of claim 2, wherein the semantic distance is at least partially a determination of similarity between the set of information concerning pursuit of the deal and elements of previous deals at least partially completed by the enterprise.

4. The system of claim 2, wherein the set of context-aware information item recommendations are numerically ranked based upon the semantic distance from the context-aware query.

5. The system of claim 1, comprising a third portion of the set of information from a pursuit process manager that provides context-aware resources relevant to progression toward the completed deal.

6. The system of claim 1, comprising an RDF triple generator to supply RDF triples to the RDF triple store, wherein the RDF triple generator extracts data concerning the enterprise's at least partially completed deals from either of a deal data store and a deal and services network to at least partially generate an RDF triple.

7. The system of claim 6, comprising utilization of an ontology model to generate the RDF triple.

8. The system of claim 6, comprising utilization of a semantic web application to generate the RDF triple.

9. A non-transitory machine-readable medium storing a set of instructions to determine context-aware information item recommendations for deals, wherein the set of instructions is executable by a processor to cause a computer to:
extract a set of information concerning pursuit of a deal by an enterprise, wherein a first portion of the set comprises metadata extracted from profile pages of an electronic communication network and a second portion of the set comprises metadata extracted from a profile of elements to be included in a completed deal;
form a number of context-aware queries by utilizing the extracted set of information to provide query parameters and by a determination of relevancy for each of the query parameters; and
determine an output based upon correlation of the number of context-aware queries with content of a resource description framework (RDF) triple store, wherein the output comprises the context-aware information item recommendations for the deal.

10. The medium of claim 9, wherein the content of the RDF triple store is based at least partially upon metadata and services concerning a plurality of previous deals at least partially completed by the enterprise.

11. The medium of claim 9, comprising to numerically rank the context-aware information item recommendations based at least partially upon determinations of profitability of deals at least partially completed by the enterprise.

12. The medium of claim 9, comprising to present the context-aware information item recommendations on a deal profile page having a number of numerically ranked recommendations ranging from 2 recommendations to 30 recommendations.

13. A computer-implemented method for determining context-aware information item recommendations for deals, comprising:
extracting a set of information concerning pursuit of a deal by an enterprise, wherein:
a first portion of the set comprises metadata extracted from profile pages of an electronic communication network;
a second portion of the set comprises metadata extracted from a profile of elements to be included in a completed deal; and
a third portion of the set comprises context-aware resources relevant to progression toward the completed deal provided by a pursuit process manager;
forming a number of context-aware queries by utilizing the extracted set of information to provide query parameters and by a determination of relevancy for each of the query parameters; and
determining an output based upon correlation of the number of context-aware queries with content of a resource description framework (RDF) triple store, wherein the output comprises a ranking score for each of the context-aware information item recommendations for the deal.

14. The method of claim 13, comprising sharing profile pages of pursuit team members and profile pages of pursuit documents on the electronic communication network, including a deal profile page upon which the ranking score is shown for each of the context-aware information item recommendations.

15. The method of claim 14, comprising updating the context-aware information item recommendations based at least partially upon additional information extracted from any of updated profile pages on the electronic communication network, an updated profile of elements to be included in the completed deal, and an update of the context-aware resources of the pursuit process manager.
